(19) United States
(12) Patent Application Publication
(10) Pub. No.: US 2005/0221631 A1
(43) Pub. Date: Oct. 6, 2005

(54) Coaxial connector

(75) Inventor: Toru Yamaguchi, Haibara-gun (JP)

Correspondence Address: SUGHRUE MION, PLLC, 2100 PENNSYLVANIA AVENUE, N.W., SUITE 800, WASHINGTON, DC, 20037, US

(73) Assignee: YAZAKI CORPORATION

(21) Appl. No.: 11/091,441

(22) Filed: Mar. 29, 2005

(30) Foreign Application Priority Data
Mar. 30, 2004 (JP) P2004-097785

(51) Int. Cl. H01R 9/05

(52) U.S. Cl. 439/63

(57) ABSTRACT

A coaxial connector is a receptacle-type connector, and consists essentially of three constituent members, that is, an outer housing having an insulator formed integrally with a rear end wall thereof, an inner terminal mounted in a central portion of the insulator, and a shielding terminal mounted on the outer periphery of the insulator. Fixing portions of the shielding terminal are of a pressing construction. Coupling portions, coupling the insulator and the rear end wall, are arranged at substantially regular intervals around the insulator.

### BACKGROUND OF THE INVENTION

This invention relates to a receptacle-type coaxial connector for fitting on a mating coaxial connector, provided at an end portion of a coaxial cable, to be electrically connected thereto.

There have been used high frequency-compatible coaxial cables for transmitting high-frequency electrical signals. A plug-type coaxial connector is provided at an end portion of the coaxial cable. The plug-type coaxial connector is adapted to be electrically connected to a receptacle-type coaxial connector mounted on a board.

As shown in FIG. 4, the plug-type coaxial connector 1 comprises an inner terminal 4 for connection to an inner conductor 3 of the coaxial cable 2, a shielding terminal 6 for connection to an outer conductor 5 of the coaxial cable 2, and an insulator 7 provided between the inner terminal 4 and the shielding terminal 6. On the other hand, as shown in FIG. 5, the receptacle-type coaxial connector 8 for fitting on the coaxial connector 1 comprises an inner terminal 9, an insulator 10, a shielding terminal 11, an outer housing 12, and a shielding member 13 (see, for example, Patent Literature 1).

The inner terminal 9 has a front connecting portion 9a and a rear connecting portion 9b, and this inner terminal 9 is connected to the inner terminal 4 of the coaxial connector 1 through the front connecting portion 9a, and is also connected to a circuit 14a on a printed circuit board 14 through the rear connecting portion 9b. The insulator 10 is molded of an insulative material. The insulator 10 is separate from the outer housing 12. The insulator 10 is provided between the inner terminal 9 and the shielding terminal 11, and functions to insulate them from each other. The shielding terminal 11 is formed into a hollow shape, and the insulator 10 is received in a rear portion of an internal space of the shielding terminal 11. The shielding terminal 6 of the coaxial connector 1 is adapted to be inserted into a front portion of the internal space of the shielding terminal 11.

The outer housing 12 is molded of a synthetic resin material. The outer housing 12 is formed into a generally rectangular parallelepiped shape. An opening is formed in the front side of the outer housing 12, and the coaxial connector 1 can be inserted into the outer housing 12 through this opening. An opening 12a is formed in the rear side of the outer housing 12, and the shielding terminal 11, having the inner terminal 9, the insulator 10 and the shielding member 13 mounted therein, can be inserted into the outer housing 12 through this opening 12a. The shielding member 13 has electrical conductivity, and is so sized as to cover the rear side of the shielding terminal 11. The shielding member 13 has connecting portions 13a which are adapted to be connected respectively to grounding portions 14b of the printed circuit board 14.

The receptacle-type coaxial connector 8 is mounted on the printed circuit board 14 in such a manner that the coaxial connector 8 is fitted in a recess portion 14c in the printed circuit board 14. In the case where there is no limitation on the height of projecting of the coaxial connector 8 from the printed circuit board 14, a coaxial connector 8′, shown in FIG. 6, can also be used. In the coaxial connector 8′, a rear connecting portion 9′b of an inner terminal 9′ (which is one constituent member) is bent into an L-shape so as to be directed toward a circuit on the printed circuit board. Further, unlike the connecting portions 13a, connecting portions 13′a of a shielding member 13′ project from a lower end portion of this shielding member 13′, which is a different portion from the portions which the connecting portions 13a projected from.

Patent Literature 1: JP-A-2002-33161

The above receptacle-type coaxial connector 8 (8′) has a problem that the number of the component parts is large. Therefore, much time and labor are required for the assembling operation, and beside a relative positional deviation between the outer housing 12 and the inner terminal 9 may increase because of accumulated dimensional tolerances of the component parts, and as a result there is encountered a problem that frequency characteristics are adversely affected.

### SUMMARY OF THE INVENTION

This invention has been made in view of the above circumstances, and an object of the invention is to provide a receptacle-type coaxial connector in which the number of component parts, as well as the time and labor for an assembling operation, can be reduced, and also frequency characteristics can be enhanced.

(1) A coaxial connector comprising:
a housing that includes a bottom wall, four peripheral walls which is perpendicularly extended from a periphery of the bottom wall and an insulator which is integrally formed at the bottom wall, wherein a plurality of through holes are formed at a periphery of the insulator on the bottom wall;
an inner terminal that passes through the insulator; and
a shield terminal that has a plurality of fixing portions and connecting portions, which are inserted to the through holes, in which the fixing portions is fixed to the mating through holes so that the shield terminal is fixed to the bottom wall.

(2) The coaxial connector according to (1),
wherein the fixing portions are pressed into the through holes so that the shield terminal is fixed to the bottom wall.

(3) The coaxial connector according to (1),
wherein the insulator is integrally formed at a plurality of coupling portions of the bottom wall, and
wherein each of the coupling portions is arranged between the through holes at substantially regular intervals along the periphery of the insulator.

(4) The coaxial connector according to (1),
wherein the housing are made of synthesis resin.

(5) The coaxial connector according to (1),
wherein each of the inner terminal and the shield terminal is electrically connected to a print board and a terminal portion of a mating coaxial connector.

(6) The coaxial connector according to (1),
wherein the housing has fixing portions that are disposed at outside surfaces of two peripheral walls which are perpendicular to a print board viewed from a direction in which the inner terminal and the shield terminal are electrically connected to the printed board.

(7) The coaxial connector according to (1),
wherein the housing has a retaining portion that retains a mating coaxial connector and is disposed at a inside surface of the peripheral wall.

(8) The coaxial connector according to (1),
wherein the housing has guiding portions that guide a mating coaxial connector and are disposed at insides of the peripheral walls.

(9) The coaxial connector according to (1),
wherein the shield terminal covers the inner terminal in the housing.

(10) A method of forming a coaxial connector comprising:
a housing that includes a bottom wall, four peripheral walls which is perpendicularly extended from a periphery of the bottom wall and an insulator which is formed at the bottom wall, wherein a plurality of through holes are formed at a periphery of the insulator on the bottom wall;
an inner terminal that passes through the insulator; and
a shield terminal that has a plurality of fixing portions and connecting portions, which are inserted to the through holes, in which the fixing portions is fixed to the mating through holes so that the shield terminal is fixed to the bottom wall, the method comprising:
forming the insulator integrally with the bottom wall.

(11) The method of forming the coaxial connector according to (10),
wherein the fixing portions are pressed into the through holes so that the shield terminal is fixed to the bottom wall.

(12) The method of forming the coaxial connector according to (10),
wherein a plurality of coupling portions are coupled the insulator to the bottom wall integrally, and
wherein each of the coupling portions is arranged between the through holes at substantially regular intervals along the periphery of the insulator.

According to the invention, the insulator is formed integrally with the bottom wall of the housing. The shielding terminal is inserted into the bottom wall of the housing to be fixed thereto. The coaxial connector of the invention is formed by the three component parts. Therefore, there is achieved an advantage that the number of the component parts, as well as the time and labor for the assembling operation, can be reduced. And besides, there is achieved an advantage that frequency characteristics can be enhanced.

According to the invention, the shielding terminal is fixed by pressing into the bottom wall of the housing having the insulator. Therefore, there is achieved an advantage that the shielding terminal can be easily fixed.

According to the invention, a molten synthetic resin can smoothly flow into a cavity portion for molding the insulator during a molding operation. Therefore, there is achieved an advantage that the moldability of the insulator can be enhanced.

### BRIEF DESCRIPTION OF THE DRAWING

FIG. 1 shows one preferred embodiment of a coaxial connector of the present invention, and FIG. 1A is a front-elevational view, FIG. 1B is a cross-sectional view taken along the line A-A of FIG. 1A, and FIG. 1C is a cross-sectional view taken along the line B-B of FIG. 1A.

FIG. 2 shows the coaxial connector of FIG. 1, and FIG. 2A is a plan view, FIG. 2B is a side-elevational view, and FIG. 2C is a rear view.

FIG. 3 is an enlarged view of a portion C of FIG. 2C.

FIG. 4 is a cross-sectional view of a related plug-type coaxial connector.

FIG. 5 is an exploded, perspective view of a related receptacle-type coaxial connector.

FIG. 6 is an exploded, perspective view of a modified example of the coaxial connector of FIG. 5.

### DETAIL DESCRIPTION OF PREFERRED EMBODIMENTS

The present invention will now be described with reference to the drawings.

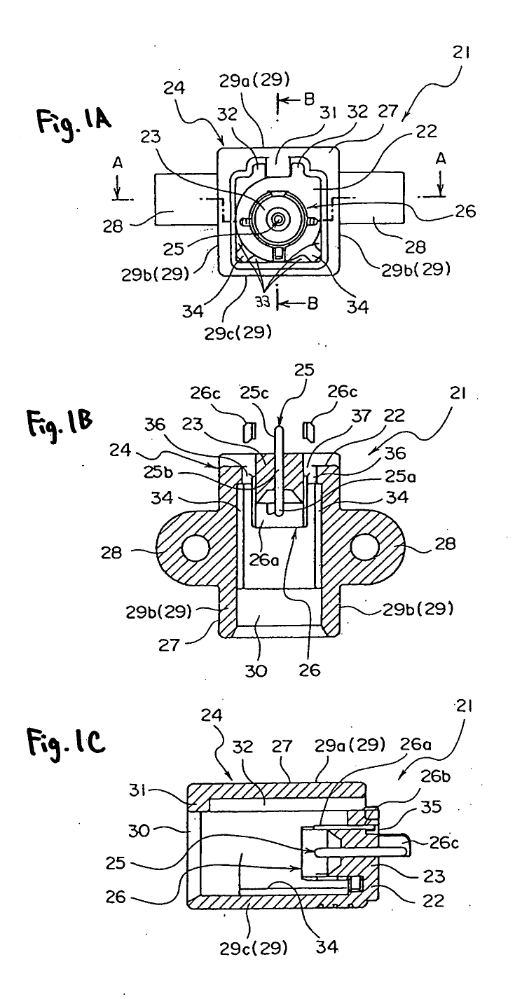

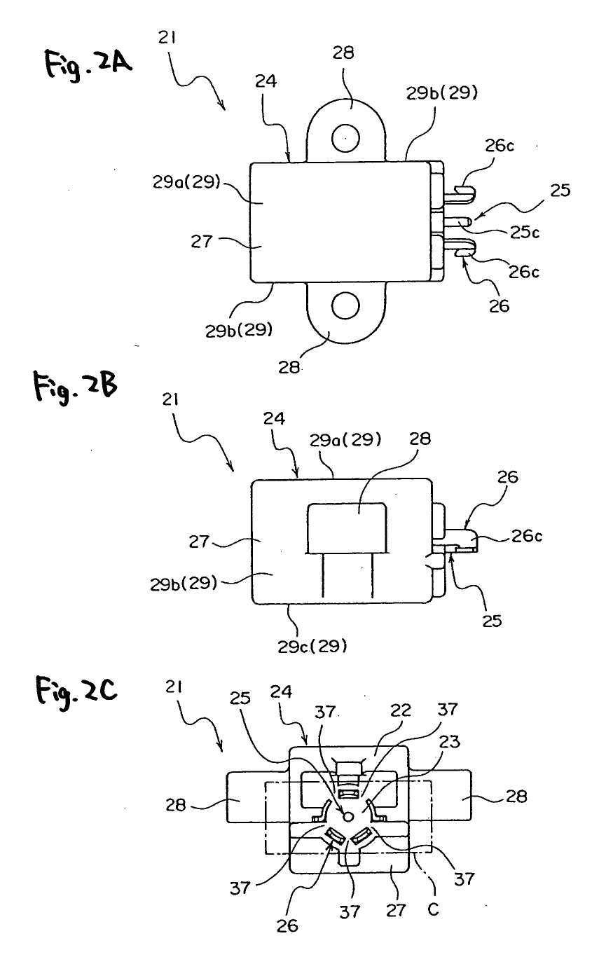

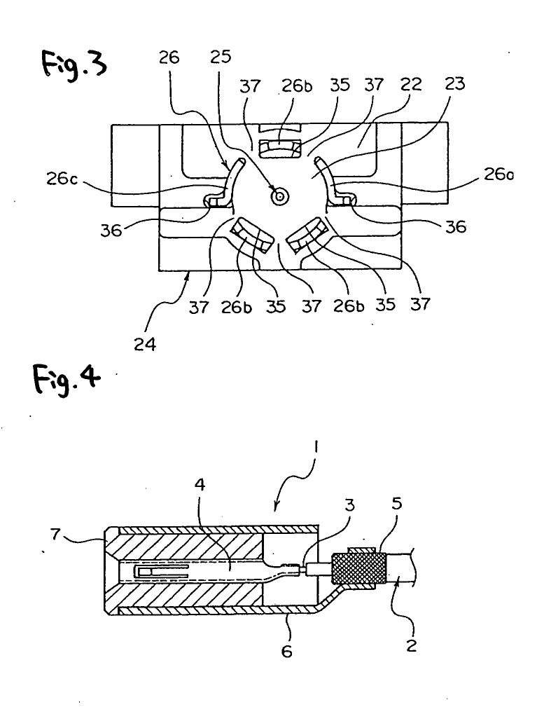

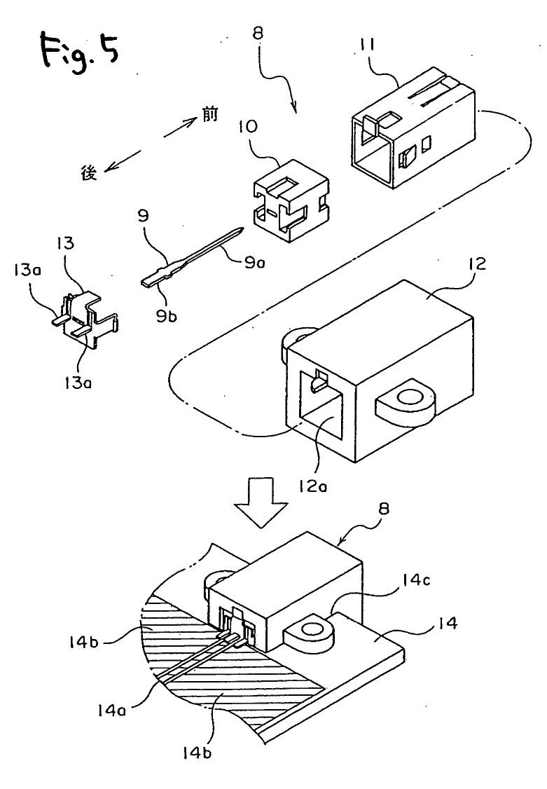

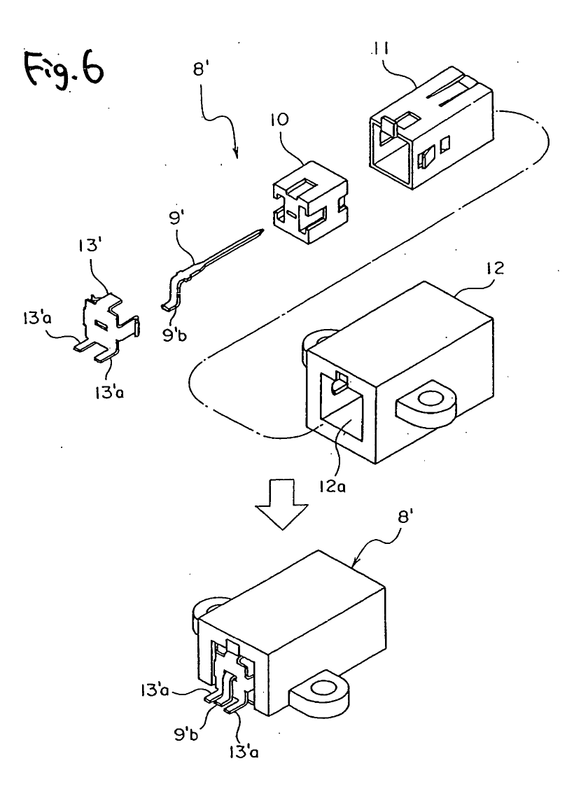

FIG. 1 shows one preferred embodiment of a coaxial connector of the present invention, and FIG. 1A is a front-elevational view, FIG. 1B is a cross-sectional view taken along the line A-A of FIG. 1A, and FIG. 1C is a cross-sectional view taken along the line B-B of FIG. 1A. FIG. 2 shows the coaxial connector of FIG. 1, and FIG. 2A is a plan view, FIG. 2B is a side-elevational view, and FIG. 2C is a rear view. FIG. 3 is an enlarged view of a portion C of FIG. 2C.

In FIGS. 1 to 3, reference numeral 21 denotes the coaxial connector of the invention. As shown in the drawings, the coaxial connector 21 of the invention is a receptacle-type connector, and consists essentially of three constituent members, that is, an outer housing 24 having an insulator 23 formed integrally with a bottom wall (a rear end wall) 22 thereof, an inner terminal 25 mounted in a central portion of the insulator 23, and a shielding terminal 26 mounted on the outer periphery of the insulator 23. The constituent members will be described below.

The outer housing 24 is molded of a synthetic resin material, and includes a body portion 27 of a generally rectangular parallelepiped shape, and fixing portions 28 formed respectively on opposite (right and left) side surfaces of the body portion 27. The outer housing 24 is fitted into a recess portion in a printed circuit board (not shown), and then is fixed thereto by screws. The body portion 27 has four peripheral walls (side walls) 29 and the rear end wall 22, and is formed into a box-like shape with an open front side or end. Reference numeral 30 denotes an opening through which a mating coaxial connector (not shown) can be inserted into the outer housing 24.

A retaining portion 31 for fitting into and retaining the mating coaxial connector (not shown) is formed on an inner surface of the upper side wall 29a of the body portion 27. Concave guide portions 32 for guiding the mating coaxial connector (not shown) are formed respectively on opposite (right and left) sides of the lock portion 31. Convex guide portions 33 and concave guide portions 34 for guiding the mating coaxial connector (not shown) are formed on the inner surfaces of the right and left side walls 29b and lower side wall 29c of the body portion 27. The fixing portions 28 are formed integrally on the outer surfaces of the right and left side walls 29b, respectively.

The insulator 23 is formed integrally with the rear end wall 22 as described above. The insulator 23 has a cylindrical shape, and is formed at a middle portion of the rear end wall 22. The insulator 23 is interposed between the inner terminal 25 and the shielding terminal 26, and functions to insulate them from each other. The inner terminal 25 is mounted in a through hole formed at the central portion of the insulator 23. The shielding terminal 26 is mounted on the outer periphery of the insulator 23.

The inner terminal 25 is mounted in the insulator 23 by either pressing or insert molding. The shielding terminal 26 is mounted on the insulator 23, utilizing a plurality of through holes 35 and 36 that are formed through the rear end wall 22, and are arranged around the insulator 23.

The insulator 23 is made continuous with the rear end wall 22 by a plurality of coupling portions 37 each extending between the corresponding adjacent through holes 35, 36. The plurality of through holes 35 and 36 (and hence the plurality of the coupling portions 37) are arranged at substantially regular intervals along the periphery of the insulator 23. This arrangement is adopted in order to enhance the moldability of the insulator 23 (The resin can flow efficiently during the molding operation).

The inner terminal 25 is a pin-like member made of electrically conductive metal, and includes a front connecting portion 25a, a fixing portion 25b and a rear connecting portion 25c. The front connecting portion 25a is adapted to contact an inner terminal of the mating coaxial connector (not shown) to be electrically connected thereto. The fixing portion 25b is fixed to the central portion of the insulator 23. The rear connecting portion 25c is adapted to be connected to a circuit on the printed circuit board (not shown).

The shielding terminal 26 is a member made of electrically conductive metal, and includes a front connecting portion 26a of a cylindrical shape, a plurality of fixing portions 26b extending from rear portions of the front connecting portion 26a, and a plurality of rear connecting portions 26c extending from rear portions of the front connecting portion 26a. The front connecting portion 26a is adapted to be contacted at its outer surface with a shielding terminal of the mating coaxial connector (not shown) so as to be electrically connected thereto. A rear portion of the front connecting portion 26a is held at its inner surface on the insulator 23.

The fixing portions 26b are inserted respectively into the through holes 35 to be pressed in these through holes, respectively. The fixing portions 26b are provided for fixing the shielding terminal 26. The fixing portions 26b do not always need to be fixed by pressing, and instead the fixing portions 26b can be so formed as to extend through the respective through holes 35, in which case rear end portions of these fixing portions 26b, projecting rearwardly from the respective through holes 35, are bent, thereby fixing the fixing portions 26b (The fixing by pressing is preferred since the efficiency of the assembling operation is enhanced).

The rear connecting portions 26c are inserted respectively into the through holes 36 to project rearwardly from these through holes 36, and are adapted to be connected to grounding portions on the printed circuit board. The rear connecting portions 26c are disposed respectively at opposite sides of the rear connecting portion 25c of the inner terminal 25.

As described above with reference to FIGS. 1 to 3, the coaxial connector 21 of the invention is formed by the three constituent members, that is, the outer housing 24 having the insulator 23 formed integrally therewith, the inner terminal 25 and the shielding terminal 26. Therefore, there is achieved an advantage that the number of the component parts, as well as the time and labor for the assembling operation, is reduced as compared with the related construction. And besides, since the number of the component parts is smaller as compared with the related construction, a relative positional deviation between the outer housing 24 and the inner terminal 25 due to accumulated dimensional tolerances of the component parts can be reduced to a minimum, and as a result there is achieved an advantage that frequency characteristics can be enhanced. Furthermore, the insulator 23 is prevented from shaking or moving relative to the outer housing 24 since the insulator 23 is formed integrally with the outer housing 24, and this also achieves an advantage that the frequency characteristics can be enhanced. Furthermore, because of the above construction and structure, the coaxial connector of the invention can be provided at a low cost.

Various modifications of the above embodiment can be made without departing from the subject matter of the invention.

1. A coaxial connector comprising:
a housing that includes a bottom wall, four peripheral walls which is perpendicularly extended from a periphery of the bottom wall and an insulator which is integrally formed at the bottom wall, wherein a plurality of through holes are formed at a periphery of the insulator on the bottom wall;
an inner terminal that passes through the insulator; and
a shield terminal that has a plurality of fixing portions and connecting portions, which are inserted to the through holes, in which the fixing portions is fixed to the mating through holes so that the shield terminal is fixed to the bottom wall.

2. The coaxial connector according to claim 1,
wherein the fixing portions are pressed into the through holes so that the shield terminal is fixed to the bottom wall.

3. The coaxial connector according to claim 1,
wherein the insulator is integrally formed at a plurality of coupling portions of the bottom wall, and
wherein each of the coupling portions is arranged between the through holes at substantially regular intervals along the periphery of the insulator.

4. The coaxial connector according to claim 1,
wherein the housing are made of synthesis resin.

5. The coaxial connector according to claim 1,
wherein each of the inner terminal and the shield terminal is electrically connected to a print board and a terminal portion of a mating coaxial connector.

6. The coaxial connector according to claim 1,
wherein the housing has fixing portions that are disposed at outside surfaces of two peripheral walls which are perpendicular to a print board viewed from a direction in which the inner terminal and the shield terminal are electrically connected to the printed board.

7. The coaxial connector according to claim 1,
wherein the housing has a retaining portion that retains a mating coaxial connector and is disposed at a inside surface of the peripheral wall.

8. The coaxial connector according to claim 1,
wherein the housing has guiding portions that guide a mating coaxial connector and are disposed at insides of the peripheral walls.

9. The coaxial connector according to claim 1,
wherein the shield terminal covers the inner terminal in the housing.

10. A method of forming a coaxial connector comprising:
a housing that includes a bottom wall, four peripheral walls which is perpendicularly extended from a periphery of the bottom wall and an insulator which is formed at the bottom wall, wherein a plurality of through holes are formed at a periphery of the insulator on the bottom wall;
an inner terminal that passes through the insulator; and
a shield terminal that has a plurality of fixing portions and connecting portions, which are inserted to the through holes, in which the fixing portions is fixed to the mating through holes so that the shield terminal is fixed to the bottom wall, the method comprising:
forming the insulator integrally with the bottom wall.

11. The method of forming the coaxial connector according to claim 10,
wherein the fixing portions are pressed into the through holes so that the shield terminal is fixed to the bottom wall.

12. The method of forming the coaxial connector according to claim 10,
wherein a plurality of coupling portions are coupled the insulator to the bottom wall integrally, and
wherein each of the coupling portions is arranged between the through holes at substantially regular intervals along the periphery of the insulator.
